(19) United States
(12) Patent Application Publication
(10) Pub. No.: US 2025/0370499 A1
(43) Pub. Date: Dec. 4, 2025

(54) ALL-IN-ONE COMPUTER

(71) Applicant: COMPAL ELECTRONICS, INC., Taipei City (TW)

(72) Inventors: I-Lung Chen, Taipei City (TW); Chin-Rang Ku, Taipei City (TW); Chang-Chia Liu, Taipei City (TW); Ming-Sheng Shih, Taipei City (TW)

(73) Assignee: COMPAL ELECTRONICS, INC., Taipei City (TW)

(21) Appl. No.: 19/215,378

(22) Filed: May 22, 2025

Related U.S. Application Data
(60) Provisional application No. 63/652,651, filed on May 28, 2024.

(51) Int. Cl. G06F 1/16

(52) U.S. Cl. CPC G06F 1/1605

(57) ABSTRACT

An all-in-one computer including a display host, a computing host, and a first hinge is provided. The display host includes a stand and a main screen. The stand supports the main screen on a platform. The computing host is electrically connected to the display host. The computing host includes a computing module and a vice screen. The main screen and the vice screen respectively stand on the platform. The first hinge is connected between the main screen and the computing host. A display area of the main screen is greater than a display area of the vice screen. The computing module drives the main screen and the vice screen to respectively output a first display content and a second display content.

### CROSS-REFERENCE TO RELATED APPLICATION

This application claims the priority benefit of U.S. provisional application Ser. No. 63/652,651, filed on May 28, 2024. The entirety of the above-mentioned patent application is hereby incorporated by reference herein and made a part of this specification.

### BACKGROUND

### Technical Field

The disclosure relates to a computer, and in particular to an all-in-one computer.

### Description of Related Art

Among current computer types, an all-in-one (AIO) computer that combines a host with a display is proposed, which may more conveniently configure related elements in the same space to obtain a compact structural configuration, while also being easily favored by users due to the simple appearance design.

Generally speaking, efficient all-in-one computers are usually equipped with exclusively designed motherboards and heat dissipation systems. Such customized designs often require high development costs and design and manufacturing time, so the release date cannot be shortened. Furthermore, current all-in-one computers often lack flexible configuration of filming lens and usage requirement of device expansion when being used, so related activities, such as game live streaming, multi-device collaboration, and artificial intelligence (AI) recognition, required by the current Internet generation cannot be satisfied.

### SUMMARY

The disclosure provides an all-in-one computer, which uses a motherboard of a notebook computer as the design core, thereby reducing costs and time required for design development and manufacturing, and is equipped with a movably configured lens assembly to satisfy various usage requirements at the same time.

An all-in-one computer of the disclosure includes a display host, a computing host, and a first hinge. The display host includes a stand and a main screen. The stand supports the main screen on a platform. The computing host is electrically connected to the display host. The computing host includes a computing module and a vice screen. The main screen and the vice screen respectively stand on the platform. The first hinge is connected between the main screen and the computing host. A display area of the main screen is greater than a display area of the vice screen. The computing module drives the main screen and the vice screen to respectively output a first display content and a second display content.

An all-in-one computer of the disclosure includes a display host, a computing host, a first hinge, and a heat dissipation module. The display host includes a stand and a main screen. The stand supports the main screen on a platform. The computing host is electrically connected to the display host. The first hinge is connected between the main screen and the computing host. The heat dissipation module is disposed in the computing host. The heat dissipation module includes a first fan and a second fan. The first fan provides an inlet airflow from an external environment to an interior of the computing host, and the second fan provides at least one discharge airflow from the interior of the computing host to the external environment.

Based on the above, the main screen of the display host of the all-in-one computer stands on the platform through the stand, and the computing host of the all-in-one computer is connected beside the main screen through the first hinge and is suspended above the platform. The computing host includes the computing module and the vice screen, so the all-in-one computer may have the main screen and the vice screen respectively standing on the platform. In this way, the computing module of the computing host may be standardized by adopting a motherboard module of universal specifications, effectively saving design development costs and shortening the release date. Furthermore, the vice screen and the main screen of the computing host may respectively input the first display content and the second display content to provide the all-in-one computer with an additional expansion display, and the vice screen may also pivotally rotate relative to the main screen through the first hinge to adjust the viewing angle.

### BRIEF DESCRIPTION OF THE DRAWINGS

FIG. 1 is a schematic diagram of an all-in-one computer according to an embodiment of the disclosure.

FIG. 2 illustrates the all-in-one computer of FIG. 1 from another perspective.

FIG. 3 illustrates another state of an all-in-one computer.

FIG. 4 is a schematic diagram illustrating some components of an all-in-one computer.

FIG. 5 illustrates a lens assembly of an all-in-one computer.

FIG. 6 and FIG. 7 respectively illustrate different usage states of a lens assembly.

FIG. 8 and FIG. 9 respectively illustrate different usage states of an all-in-one computer.

FIG. 10 is a schematic diagram illustrating some components of an all-in-one computer.

FIG. 11 is a schematic diagram illustrating some components of an all-in-one computer.

### DESCRIPTION OF THE EMBODIMENTS

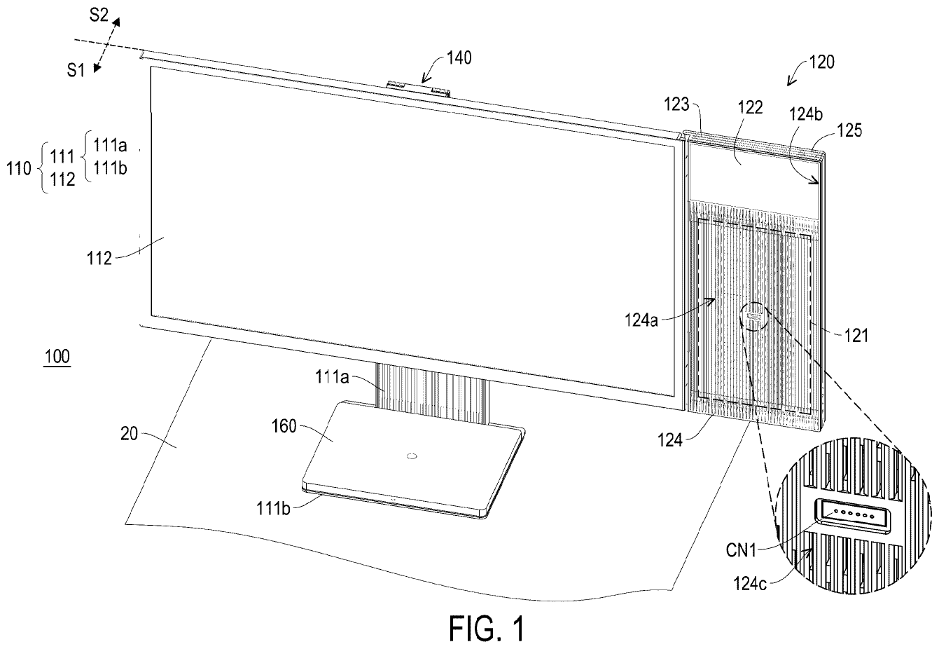

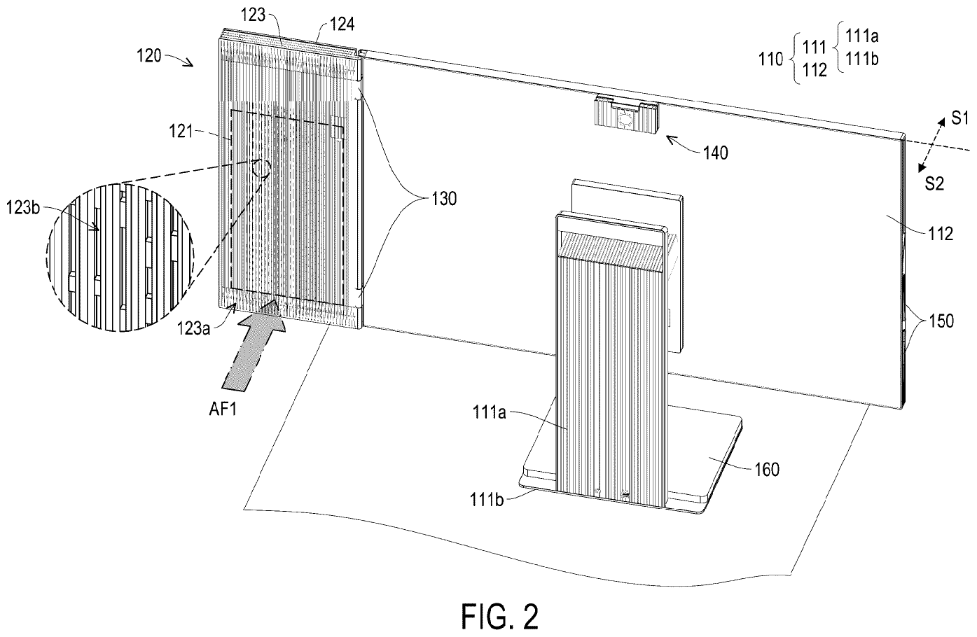

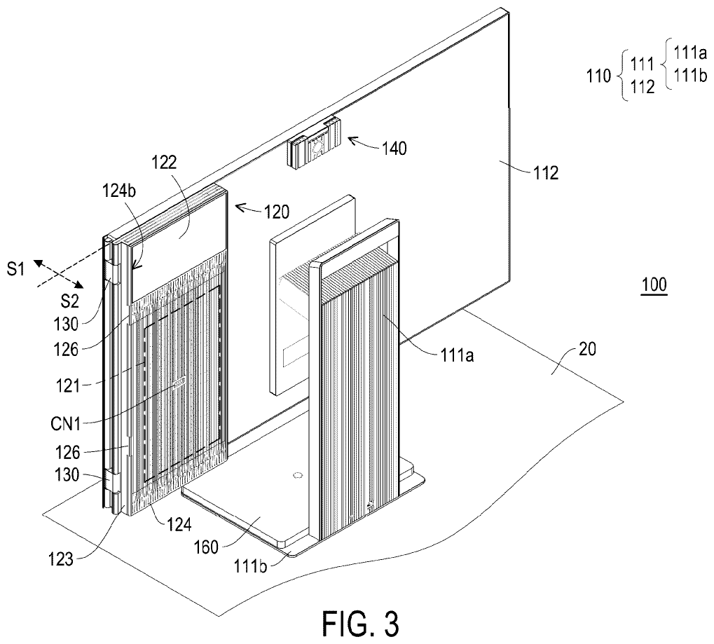

FIG. 1 is a schematic diagram of an all-in-one computer according to an embodiment of the disclosure. FIG. 2 illustrates the all-in-one computer of FIG. 1 from another perspective. FIG. 3 illustrates another state of an all-in-one computer. Please refer to FIG. 1 to FIG. 3 together. An all-in-one computer 100 includes a display host 110, a computing host 120, and a first hinge 130. The display host 110 includes a stand 111 and a main screen 112, wherein the stand 111 supports the main screen 112 on a platform 20. The computing host 120 is electrically connected to the display host 110. The computing host 120 includes a computing module 121 and a vice screen 122. The main screen 112 and the vice screen 122 respectively stand on the platform 20. The first hinge 130 is connected between the main screen 112 and the computing host 120, so that the computing host 120 may pivotally rotate relative to the main screen 112. A display area of the main screen 112 is greater than a display area of the vice screen 122, and the computing module 121 drives the main screen 112 and the vice screen 122 to respectively output a first display content and a second display content.

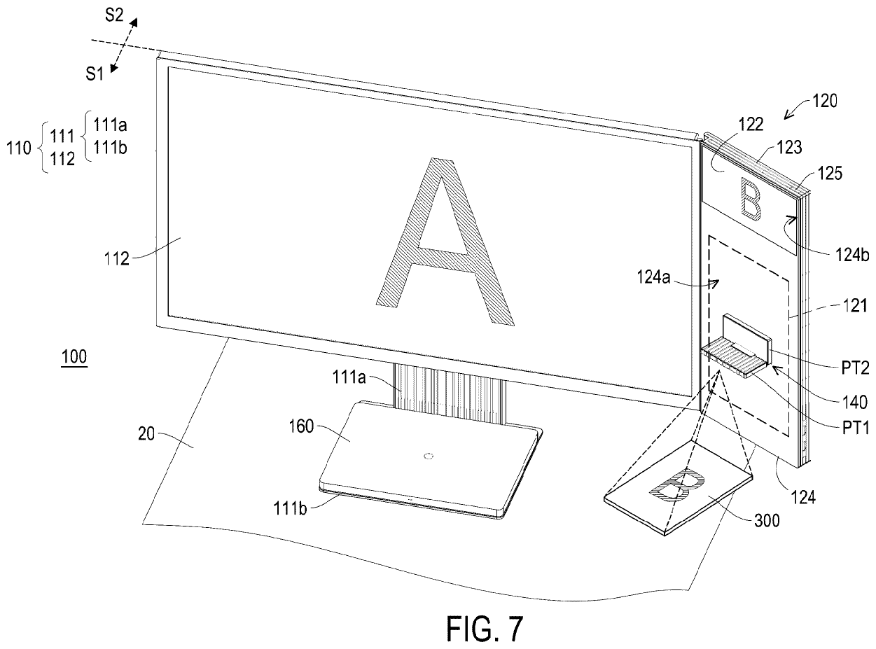

In the embodiment, the first hinge 130 is a dual-hinge structure. The computing host 120 may pivotally rotate relative to the display host 110 through the first hinge 130 and be suspended above the platform 20, and may switch between an expanded state (such as shown in FIG. 1 or FIG. 2) and a collapsed state (such as shown in FIG. 3). In the expanded state, the main screen 112 and the vice screen 122 are both facing a front side S1 of the display host 110, and in a preferred embodiment, the computing host 120 preferably forms an obtuse angle relative to the display host 110 in the direction toward the front side S1 (such as FIG. 7 described later). In the collapsed state, the computing host 120 is folded on a rear side S2 of the display host 110, so that the main screen 112 and the vice screen 122 face away from each other. Therefore, the viewing angle of the vice screen 122 of the computing host 120 may be adjusted through the first hinge 130 to meet usage requirements.

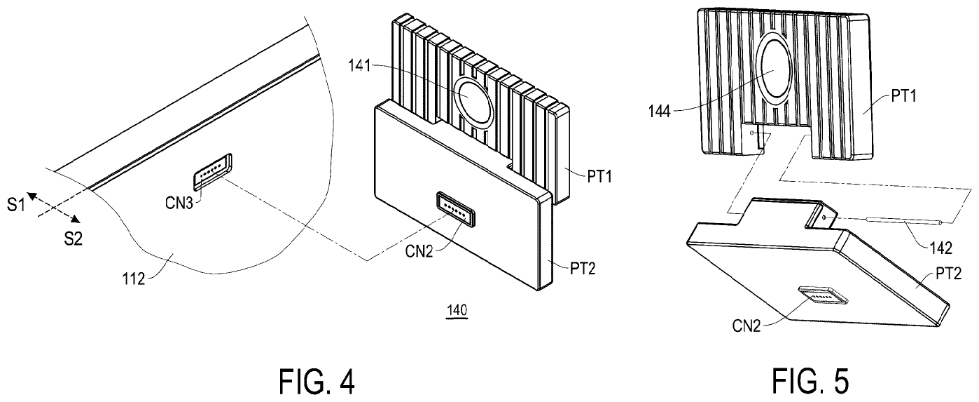

FIG. 4 is a schematic diagram illustrating some components of an all-in-one computer. FIG. 5 illustrates a lens assembly of an all-in-one computer. Please refer to FIG. 4 and FIG. 5, and compare with FIG. 2. In the embodiment, the all-in-one computer 100 further includes a detachable lens assembly 140. The lens assembly 140 includes a lens module 141, an electrical connector module CN2, and a second hinge 142. Specifically, the lens assembly 140 includes a first part PT1 and a second part PT2, wherein the lens module 141 is disposed on the first part PT1, the electrical connector module CN2 is disposed on the second part PT2, and the first part PT1 and the second part PT2 are pivotally connected to each other through the second hinge 142. Accordingly, as shown in FIG. 5 (and compare with FIG. 1 to obtain the relative position), the lens assembly 140 is docked (structurally assembled) to an electrical connector module CN3 of the display host 110 through the electrical connector module CN2, and is electrically connected to the computing host 120 via the display host 110, so as to form a network filming architecture of the all-in-one computer 100. The lens module 141 may pivotally rotate relative to the second part PT2 along with the first part PT1, so that the lens module 141 faces the rear side S2 as shown in FIG. 1 or faces the front side S1 after being installed on the electrical connector module CN3 as shown in FIG. 4.

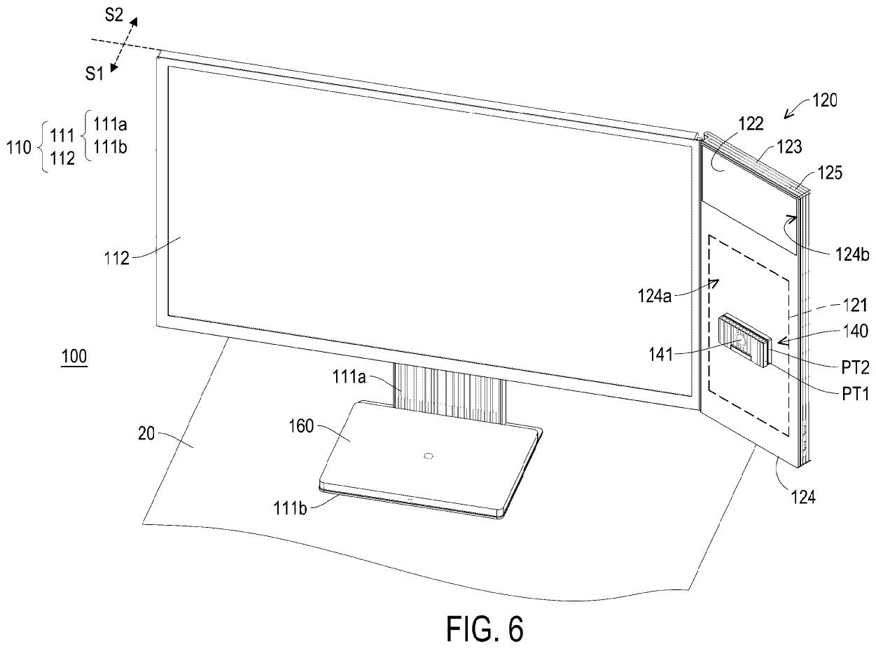

It should be noted in advance that in order to facilitate the subsequent description of the usage state of the lens assembly 140, lines of an air inlet 124c shown in FIG. 1 will be omitted in FIG. 6 to FIG. 8. FIG. 6 and FIG. 7 respectively illustrate different usage states of a lens assembly. Please refer to FIG. 6 first and compare with FIG. 1. In addition to the rear side S2 of the display host 110, the lens assembly 140 may also form another form of usage state through docking (structurally assembling) the electrical connector module CN2 to an electrical connector module CN1 of the computing host 120. As shown in FIG. 6, since the computing host 120 may pivotally rotate relative to the display host 110 through the first hinge 130, the lens assembly 140 may adjust the filming angle relative to the user. At the same time, the filming content of the user may be further (displayed) reflected to the vice screen 122 of the computing host 120, thereby enabling a side-recording mode during the user's Internet live broadcast.

In addition, please refer to FIG. 7. Although the lens assembly 140 shown is also docked to the computing host 120, the lens module 141 may face the platform 20 through the second hinge 142 of the lens assembly 140. In this way, as shown in FIG. 7, the lens module 141 may capture a document 300 placed on the platform 20, and transmit the captured image data to the vice screen 122 of the computing host 120 or the main screen 112 of the display host 110. For illustration, the former is taken as an example here, so that the first display content of the main screen 112 and the second display content of the vice screen 122 are different from each other.

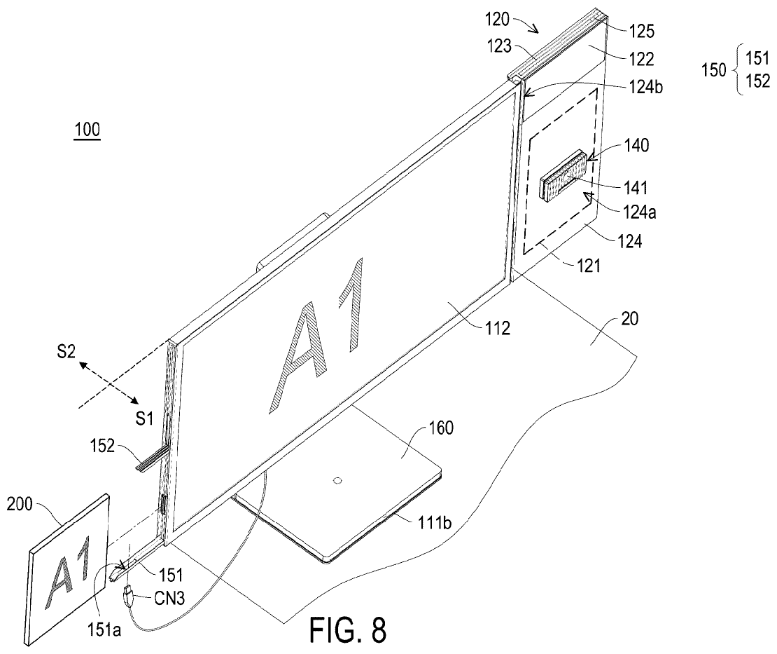

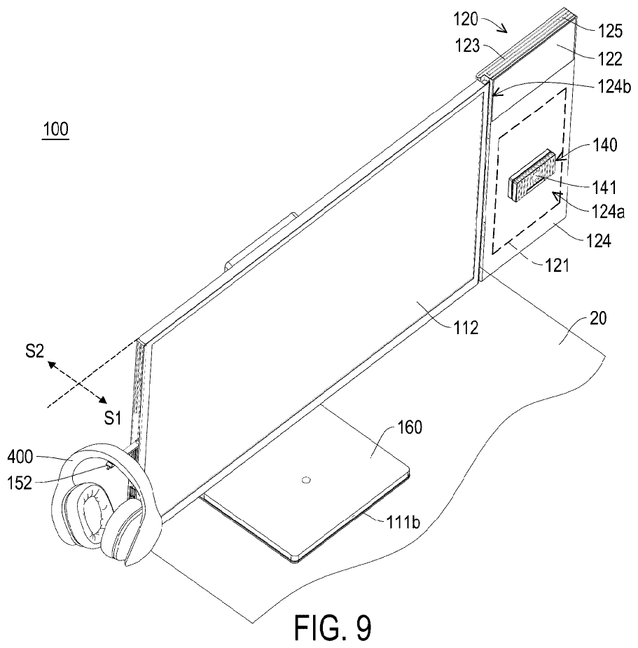

FIG. 8 and FIG. 9 respectively illustrate different usage states of an all-in-one computer. Please refer to FIG. 8 first. In the embodiment, the all-in-one computer 100 further includes a storage stand 150, which may be folded for storage or unfolded at a side of the main screen 112 and opposite to the computing host 120. When the storage stand 150 is unfolded at the side of the main screen 112, an external object 200 (or an earphone 400 described later) is adapted to be carried by the storage stand 150. Here, the external object 200 is, for example, a mobile phone or a tablet computer.

The storage stand 150 of the embodiment includes a fixed unit 151 and a moving unit 152. After the moving unit 152 is movably coupled to the side of the main screen 112 and is located on the fixed unit 151 after being unfolded at the main screen 112. The external object 200 is adapted to be clamped between the fixed unit 151 and the moving unit 152. The storage stand 150 may be compatible with the external object 200 of different sizes through the movable moving unit 152. Here, the external object 200 is a portable mobile device. The portable mobile device is adapted to be connected to the computing host 120 via wireless or wired signals, and a third display content of the portable mobile device is different from the second display content appearing on the vice screen 122. Taking the electrical connector module CN3 as an example of the wired signal connection, an end of the electrical connector module CN3 is electrically connected to the display host 110 or the computing host 120, and the other end passes through an opening 151a of the fixed unit 151 and is electrically connected to the external object 200 carried by the storage stand 150. In addition to providing charging/discharging for the external object 200 through the display host 110 or the computing host 120 through the electrical connector module CN3, the third display content of the portable mobile device is different from the display content of the vice screen 122, but may match or even be consistent with the first display content of the main screen 112, so that the display screen of the external object 200 and the main screen 112 of the display host 110 may be an extended display desktop of each other or synchronized display desktops.

FIG. 9 illustrates another usage manner of the storage stand 150, that is, after the moving unit 152 is moved to a preset position, the storage stand 150 may be used as a hanging rack structure for storing the earphone 400 or other objects.

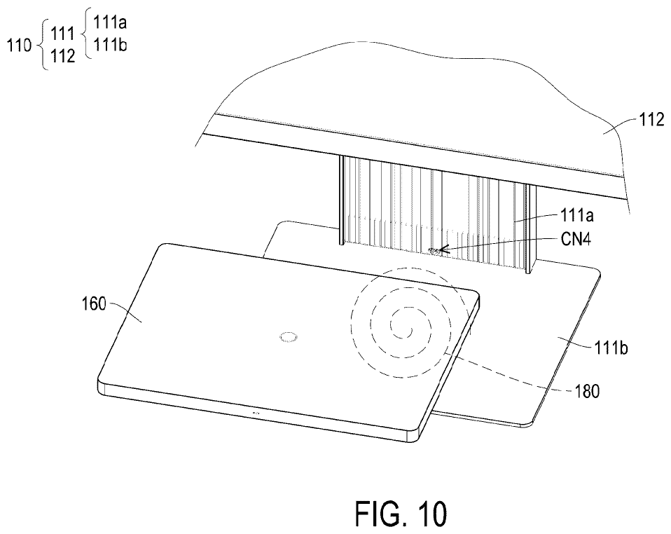

FIG. 10 is a schematic diagram illustrating some components of an all-in-one computer. Please refer to FIG. 10. The all-in-one computer 100 of the embodiment further includes an expansion accessory 160, which is disposed on a frame 111a or a base 111b of the stand 111 and is electrically connected to the computing module 121. The frame 111a is connected between the base 111b and the main screen 112. Here, the display host 110 further includes an electrical connector module CN4 disposed on the stand 111. When the expansion accessory 160 is placed on the base 111b of the stand 111, the expansion accessory 160 may be charged/discharged through the electrical connector module CN4. An end of the electrical connector module CN3 may be connected to the electrical connector module CN4. On the other hand, the all-in-one computer 100 of the embodiment further includes a wireless charging module 180, which is disposed on the base 111b of the stand 111 and is electrically connected to the computing host 120 (or electrically connected to the computing host 120 via the display host 110). Therefore, when the expansion accessory 160 capable of receiving wireless charging/discharging is placed on the base 111b, the wireless charging module 180 may be activated to charge/discharge the expansion accessory 160.

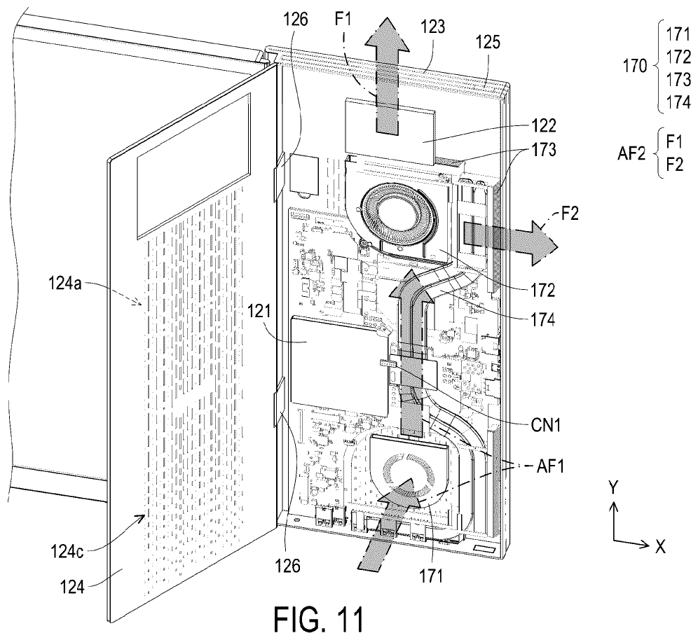

FIG. 11 is a schematic diagram illustrating some components of an all-in-one computer. Please refer to FIG. 11, and compare it with FIG. 1 and FIG. 2. In the embodiment, the all-in-one computer 100 further includes a heat dissipation module 170, which is disposed in the computing host 120. The heat dissipation module 170 includes a first fan 171 and a second fan 172. The first fan 171 provides an intake airflow AF1 from the external environment toward the interior of the computing host 120, and the second fan 172 provides at least one discharge airflow AF2 from the interior of the computing host 120 to the external environment.

Specifically, the computing host 120 has a first air inlet surface 124a and a second air inlet surface 123a opposite to each other (as shown in FIG. 2), and the first fan 171 is located between the first air inlet surface 124a and the second air inlet surface 123a, so that the intake airflow AF1 sucked in by the first fan 171 passes through the first air inlet surface 124a and the second air inlet surface 123a and enters the computing host 120. The computing host 120 includes a body 123, a cover 124, and a latch 125. The cover 124 is pivotally connected to the body 123 through a third hinge 126, the pivotal connection position is adjacent to the first hinge 130, and the latch 125 is disposed on at least one of the body 123 and the cover 124, so that when the cover 124 pivotally rotates relative to the body 123 and is closed on the body 123, the latch 125 combines and fixes the cover 124 and the body 123 together. The cover 124 has an opening 124b, so that the vice screen 122 may pass through the cover 124 to be exposed from the computing host 120. Furthermore, please refer to FIG. 1, FIG. 2, and FIG. 11 together. The cover 124 has multiple air inlets 124c of different sizes and in elongated shapes, so as to form the first air inlet surface 124a. Similarly, the body 123 also has multiple air inlets 123b of different sizes and in elongated shapes, so as to form the second air inlet surface 123a.

A plane coordinate X-Y is provided here for reference, and the body 123 of the computing host 120 is regarded as being located on the X-Y plane. The first fan 171 and the second fan 172 of the embodiment are respectively centrifugal fans, which first take in air from the axial directions of the fans, such as the first air inlet surface 124a and the second air inlet surface 123a (as shown in FIG. 2), to absorb cold air from the external environment, and then send out the discharge airflow (a first airflow F1 and a second airflow F2 as shown in FIG. 11) in a direction perpendicular to the axial direction. Furthermore, in order to effectively provide an optimized heat dissipation mechanism for the computing module 121, the first fan 171 of the embodiment is a single-outlet fan to facilitate the introduction of the intake airflow AF1 from the external environment into the computing host 120, and especially toward a heat pipe of the heat dissipation module 170 and the second fan 172. The second fan 172 is a double-outlet fan, and the discharge airflow AF2 thereof includes the first airflow F1 and the second airflow F2. The direction of the second airflow F2 is along the positive X-axis direction and away from the main screen 112. The direction of the first airflow F1 is along the positive Y-axis direction and perpendicular to the direction of the second airflow F2. The second fan 172 is aligned with the first fan 171, and the first airflow F1 is blown out of the computing host 120 in a direction away from the first fan 171. It can be clearly seen from the flow direction of the airflow shown in FIG. 11 that since the airflow of the first fan 171 is discharged toward the second fan 172, the second fan 172 not only draws cold air from the external environment, but also further uses the airflow of the first fan 171 as an additional airflow source to increase the airflow flow rate thereof, which benefits the heat dissipation of the computing module 121.

On the other hand, the computing module 121 of the computing host 120 is equivalent to a motherboard disposed in the body 123 and is particularly a standard motherboard of a notebook computer. In other words, the all-in-one computer 100 is equivalent to regarding the computing host 120 as the host of the notebook computer, but redesigning the special airflow configuration of the heat dissipation module 170 instead of directly transplanting the airflow configuration of a conventional heat dissipation module on the notebook computer. Therefore, the all-in-one computer 100 of the disclosure not only achieves commonality but also improves the compatible range, so as to reduce issues such as excessively high costs, long development time, and lack of commonality due to customization.

In summary, in the above embodiments of the disclosure, the main screen of the display host of the all-in-one computer stands on the platform through the stand, and the computing host of the all-in-one computer is connected beside the main screen through the first hinge and is suspended above the platform, wherein the computing host includes the computing module and the vice screen, so the all-in-one computer may have the main screen and the vice screen respectively standing on the platform. In this way, the computing module of the computing host may be standardized by adopting a motherboard module of universal specifications (public specifications), effectively saving design development costs and shortening the release date. Furthermore, the vice screen and the main screen of the computing host may respectively input the first display content and the second display content to provide the all-in-one computer with an additional expansion display, and the vice screen may also pivotally rotate relative to the main screen through the first hinge to adjust the viewing angle.

On the other hand, the lens assembly of the all-in-one computer may be docked to the display host or the computing host due to the detachable feature thereof. At the same time, the lens module and the electrical connector module are respectively disposed in different and mutually pivotally connected elements, so that the filming angle may be adjusted according to requirements. In addition, the computing host may pivotally rotate relative to the display host to increase additional usage states, which is more conducive to the cooperation with the display host and the computing host to satisfy various usage requirements.

In addition, in order to achieve effective heat dissipation for the computing module disposed in the computing host, the heat dissipation module of the all-in-one computer includes the first fan and the second fan, which are respectively axial flow fans to draw cold air from the external environment into the computing host via different air inlet surfaces of the body and the cover, wherein the first fan is a single-outlet fan and is aligned with the second fan to serve as the additional airflow source of the second fan. The second fan is a dual-outlet fan, which serves as the main structure for dissipating heat from the computing module and effectively dissipates heat at related heat concentration positions through discharge airflows in different directions.

What is claimed is:

1. An all-in-one computer, comprising:
a display host, comprising a stand and a main screen, wherein the stand supports the main screen on a platform;
a computing host, electrically connected to the display host, the computing host comprising a computing module and a vice screen, wherein the main screen and the vice screen respectively stand on the platform; and
a first hinge, connected between the main screen and the computing host, wherein a display area of the main screen is greater than a display area of the vice screen, and the computing module drives the main screen and the vice screen to respectively output a first display content and a second display content.

2. The all-in-one computer according to claim 1, wherein the computing host pivotally rotates relative to the display host through the first hinge to switch between an expanded state and a collapsed state, wherein in the expanded state, the computing host forms an obtuse angle relative to the display host, and the main screen and the vice screen are both facing a front side of the display host, and in the collapsed state, the computing host is folded on a rear side of the display host, so that the main screen and the vice screen face away from each other.

3. The all-in-one computer according to claim 1, further comprising a lens assembly, wherein the lens assembly comprises a lens module, an electrical connector module, and a second hinge, wherein the electrical connector module is detachably structurally assembled to the main screen of the display host or the computing host, during structural assembly, the lens module is electrically connected to the computing module through the electrical connector module, and the second hinge is connected between the lens module and the electrical connector module, so that the lens module pivotally rotates relative to the electrical connector module through the second hinge.

4. The all-in-one computer according to claim 3, wherein image data obtained by the lens module is mapped as the second display content of the vice screen.

5. The all-in-one computer according to claim 1, further comprising a storage stand folded and stored or unfolded at a side of the main screen and opposite to the computing host, wherein when the storage stand is unfolded at the side of the main screen, an external object is adapted to be carried by the storage stand.

6. The all-in-one computer according to claim 5, wherein the storage stand comprises a fixed unit and a moving unit, wherein the moving unit is movably coupled to the side of the main screen and is located on the fixed unit after being unfolded at the main screen, and the external object is adapted to be clamped between the fixed unit and the moving unit.

7. The all-in-one computer according to claim 6, wherein the external object is a portable mobile device, wherein the portable mobile device is adapted to be connected to the computing host via wireless or wired signals, and a third display content of the portable mobile device is different from the second display content.

8. The all-in-one computer according to claim 1, further comprising an expansion accessory disposed on a frame or a base of the stand and electrically connected to the computing module, wherein the frame is connected between the base and the main screen.

9. The all-in-one computer according to claim 1, further comprising a heat dissipation module disposed in the computing host, wherein the heat dissipation module comprises a first fan and a second fan, wherein the first fan provides an intake airflow from an external environment to an interior of the computing host, and the second fan provides at least one discharge airflow from the interior of the computing host to the external environment.

10. The all-in-one computer according to claim 9, wherein the computing host has a first air inlet surface and a second air inlet surface opposite to each other, wherein the first fan is located between the first air inlet surface and the second air inlet surface, so that the intake airflow passes through the first air inlet surface and the second air inlet surface and enters the computing host via the first fan.

11. The all-in-one computer according to claim 9, wherein the discharge airflow comprises a first airflow and a second airflow, wherein a direction of the second airflow is away from the main screen, and a direction of the first airflow is perpendicular to the direction of the second airflow.

12. The all-in-one computer according to claim 11, wherein the second fan is aligned with the first fan, and the first airflow is blown out of the computing host in a direction away from the first fan.

13. The all-in-one computer according to claim 1, wherein the computing host comprises a body, a cover, and a latch, wherein the cover is pivotally connected to the body and a pivotal connection position is adjacent to the first hinge, and the latch is disposed on at least one of the body and the cover, so that when the cover pivotally rotates relative to the body and is closed on the body, the latch combines and fixes the cover and the body together.

14. The all-in-one computer according to claim 13, wherein the vice screen is exposed from the computing host through the cover.
